(19) United States
(12) Patent Application Publication
(10) Pub. No.: US 2006/0018657 A1
(43) Pub. Date: Jan. 26, 2006

(54) Method and apparatus of circuit configuration and voice traffic transport

(76) Inventors: Moshe Oron, San Rafael, CA (US); Richard B. Joerger, Davie, FL (US)

Correspondence Address: PILLSBURY WINTHROP SHAW PITTMAN LLP, P.O. BOX 10500, MCLEAN, VA, 22102, US

(21) Appl. No.: 10/897,315

(22) Filed: Jul. 21, 2004

(51) Int. Cl. H04J 14/00

(52) U.S. Cl. 398/66

(57) ABSTRACT

A method according to an embodiment of the invention includes configuring a virtual circuit according to a fixed structured data transport (SDT) structure to transport traffic for provisioned and unprovisioned voice lines supported by an ONU.

### FIELD OF THE INVENTION

The invention relates to communications networks.

### BACKGROUND

The following acronyms may appear in the description below: APON, asynchronous transfer mode (ATM) passive optical network (PON); ASIC, application-specific integrated circuit; ATM, asynchronous transfer mode; B-PON or BPON (broadband PON); CATV, community access television (cable television); CPU, central processing unit (e.g. microprocessor); EPON (Ethernet PON); FPGA, field-programmable gate array; ISDN, integrated services digital network; PON, passive optical network; POTS, plain old telephone service; PPV, pay per view; RAM, random-access memory; ROM, read-only memory; VoIP, voice over Internet Protocol; VoATM, voice over ATM; VoD, video on demand.

Optical access systems offer a potentially large bandwidth as compared to copper-based access systems. A broadband optical access system may be used, for example, to distribute a variety of broadband and narrowband communication services from a service provider's facility to a local distribution point and/or directly to the customer premises. These communication services may include telephone (e.g. POTS, VoIP, VoATM), data (e.g. ISDN, Ethernet), and/or video/audio (e.g. television, CATV, PPV, VoD) services.

FIG. 1 shows examples of two optical access network (OAN) architectures. The first example includes an optical line termination (OLT), an optical distribution network (ODN), an optical network unit (ONU), and a network termination (NT). The OLT provides the network-side interface of the OAN (e.g. a service node interface or SNI), and it may be located at a carrier's central office or connected to a central office via a fibre trunk (e.g. the OLT may include an OC-3/STM-1 or OC-12c/STM-4c interface).

The OLT may be implemented as a stand-alone unit or as a card in a backplane. The AccessMAX OLT card of Advanced Fibre Communications (Petaluma, Calif.) is one example of a superior OLT product. Other examples of OLTs include the 7340 line of OLTs of Alcatel (Paris, France), the FiberDrive OLT of Optical Solutions (Minneapolis, Minn.), and assemblies including the TK3721 EPON media access controller device of Teknovus, Inc. (Petaluma, Calif.). The OLT may communicate (e.g. via cable, bus, and/or data communications network (DCN)) with a management system or management entity, such as a network element operations system (NE-OpS), that manages the network and equipment.

On the user side, the OLT may be connected to one or more ODNs. An ODN provides one or more optical paths between an OLT and one or more ONUs. The ODN provides these paths over one or more optical fibres. The ODN may also include optional protection fibres (e.g. for backup in case of a break in a primary path).

An optical network unit (ONU) is connected to an ODN and provides (either directly or remotely) a user-side interface of the OAN. The ONU, which may serve as a subscriber terminal, may be located outside (e.g. on a utility pole) or inside a building. One or more network terminations (NTs) are connected to an ONU (e.g. via copper trace, wire, and/or cable) to provide user network interfaces (UNIs), e.g. for services such as Ethernet, video, and ATM. Implementations of such an architecture include arrangements commonly termed Fibre to the Building (FTTB), Fibre to the Curb (FTTC), and Fibre to the Cabinet (FTTCab).

The second architecture example in FIG. 1 includes an OLT, an ODN, and one or more Optical Network Terminations (ONTs). An ONT is an implementation of an ONU that includes a user port function. The ONT serves to decouple the access network delivery mechanism from the distribution at the customer premises (e.g. a single-family house or a multi-dwelling unit or business establishment). Implementations of such an architecture include arrangements commonly termed Fibre to the Home (FTTH). In some applications, an ONT may be wall-mounted.

The AccessMAX ONT 610 of Advanced Fibre Communications (Petaluma, Calif.) is one example of a superior ONT product. Other examples of ONTs include the Exxtenz Optical Network Termination of Carrier Access Corporation (Boulder, Colo.), the FiberPath 400 and 500 lines of ONTs of Optical Solutions, the 7340 line of ONTs of Alcatel, and assemblies including the TK3701 device of Teknovus, Inc.

As shown in FIG. 1, an OAN may include a number of ODNs connected to the same OLT. As shown in FIG. 2, an ODN may connect an OLT to multiple ONUs. An ODN may also be connected to both ONUs and ONTs. In some applications, the nominal bit rate of the OLT-to-ONU signal may be selected from the rates 155.52 Mbit/s and 622.08 Mbit/s, although other rates are possible for both downstream and upstream traffic.

An ODN that contains only passive components (e.g. fibre and optical splitters and/or combiners) may also be referred to as a passive optical network (PON). Depending e.g. on the particular protocol used, a PON may also be referred to, for example, as a B-PON (broadband PON), EPON (Ethernet PON), or APON (ATM PON). A OAN may include different OLTs and/or ONUs to handle different types of services (e.g. data transport, telephony, video), and/or a single OLT or ONU may handle more than one type of service. The OLT and/or one or more of the ONUs may be provided with battery backup (e.g. an uninterruptible power supply (UPS)) in case of mains power failure.

FIG. 3 shows an example of a OLT connected to a PON that includes a four-way splitter 20 and four eight-way splitters 30a-d. In this example, each of up to thirty-two ONUs may be connected to the PON via a different output port of splitters 30a-d (where the small circles represent the PON nodes depending from these ports). Other PON configurations may include different splitter arrangements. In some such configurations, for example, a path between the OLT and one ONU may pass through a different number of splitters than a path between the OLT and another ONU.

The protocol for communications between the OLT and the ONUs may be ATM-based (e.g. such that the OLT and ONUs provide transparent ATM transport service between the SNI and the UNIs over the PON), for example. Such embodiments of the invention may be applied to optical access systems that comply with one or more of ITU-T Recommendations G.983.1 (“Broadband optical access systems based on Passive Optical Networks (PON),” dated October 1998 and as corrected July 1999 and March 2002 and amended November 2001 and March 2003, along with Implementor's Guide of October 2003) and G.983.2 (“Optical Network Termination management and control interface specification for B-PON,” dated June 2002 and as amended March 2003, along with Implementor's Guide of April 2000) (International Telecommunication Union, Geneva, CH). Additional aspects of optical access systems to which embodiments of the invention may be applied are described in the aforementioned Recommendations.

For practical use of an ATM network, it may be desirable to adapt the internal characteristics of the network to those of the various services to be transported over the network. An ATM Adaptation Layer (AAL) may be used to provide generalized interworking across an ATM network for such purpose. For example, an AAL function may provide an end-to-end protocol to support users of different classes of service.

Structured Data Transport (SDT) is a data transfer mode of ATM Adaptation Layer 1 (AAL1) in which data is structured into blocks that are then segmented into cells for transfer (FIG. 4 shows a SDT cell format). One application of AAL1 SDT is to provide Circuit Emulation Services for the transport of various Constant Bit Rate (CBR) services over the ATM network. For example, AAL1 SDT may be used to carry a number of separate voice telephony lines (e.g. n×64 kbps) over a single ATM Virtual Circuit (VC). However, use of this adaptation method may become complex in a dynamic environment e.g. in which lines are added and dropped and bandwidth demand fluctuates. While ATM Adaptation Layer 2 (AAL2) supports dynamic voice channel allocation, such a method is also complex and has additional limitations as noted below.

### SUMMARY

A method of communications according to one embodiment of the invention includes obtaining the number of voice ports supported by a particular optical networking unit (ONU); mapping each of the supported voice ports to a corresponding channel of a structured data transport (SDT) structure; and establishing a virtual circuit between the ONU and an optical line termination (OLT) according to the SDT structure.

An optical line termination (OLT) according to another embodiment of the invention includes a connection admission control (CAC) configured to obtain the number of voice ports supported by an optical networking unit (ONU); an adaptation layer control configured to establish a structured data transport (SDT) structure; and a virtual circuit control configured to establish a virtual circuit between the OLT and the ONU according to the SDT structure. The OLT is configured to map each of the voice ports to a corresponding channel of the SDT structure.

### BRIEF DESCRIPTION OF THE DRAWINGS

FIG. 1 shows examples of two OAN architectures.

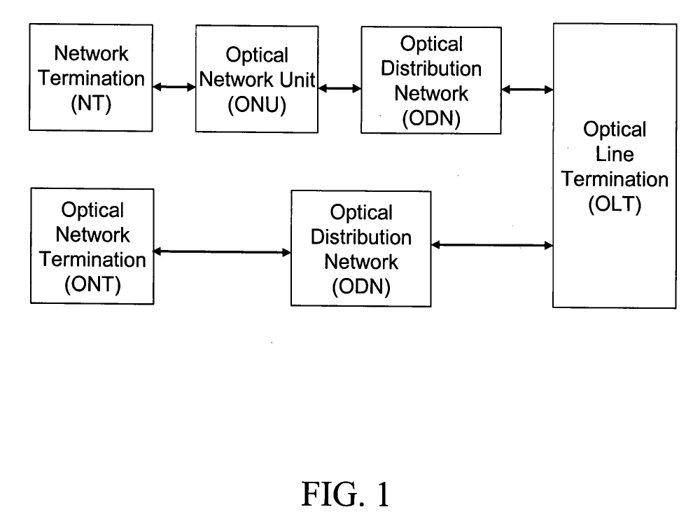

FIG. 2 shows an example of an OAN.

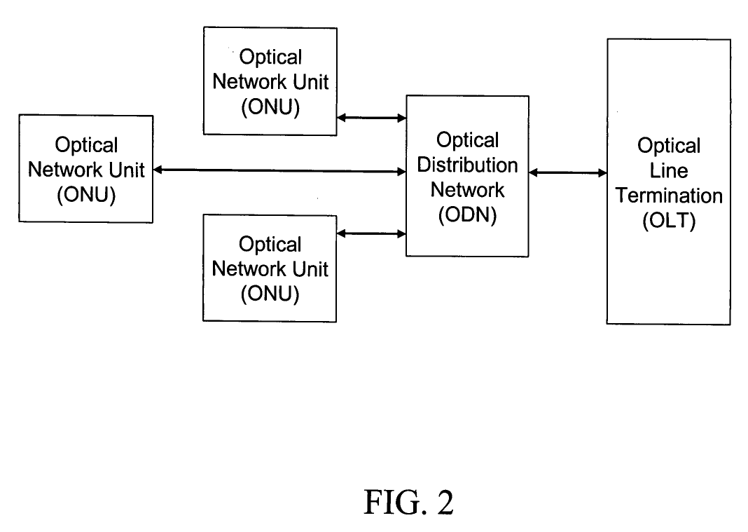

FIG. 3 shows an example of an OLT and a PON including splitters.

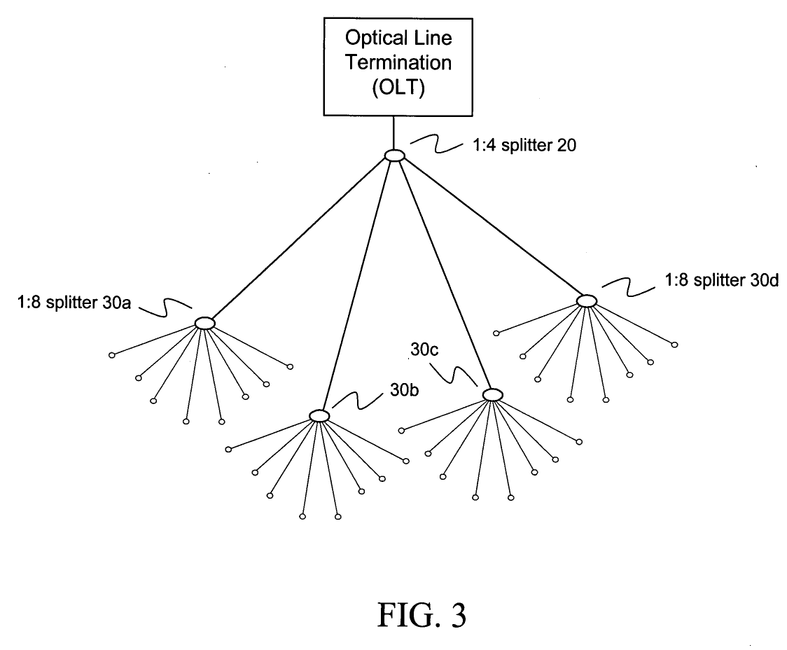

FIG. 4 shows the Structured Data Transport (SDT) format according to CCITT Recommendation I.363.

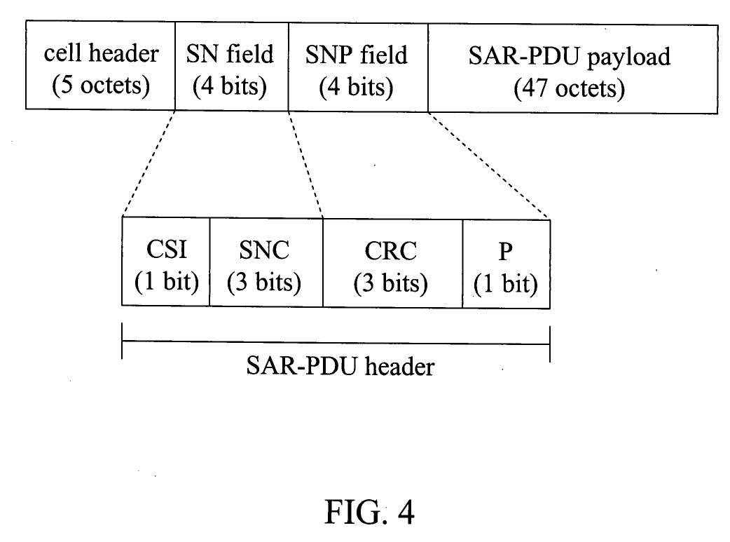

FIG. 5 shows a flowchart of a method according to an embodiment of the invention.

FIG. 6 shows a block diagram of a system according to an embodiment of the invention.

### DETAILED DESCRIPTION

Embodiments of the invention may be applied to the delivery of multiple voice line services to an ONT at a subscriber's premises over an ATM network (e.g. a PON). Different ONT types may support different numbers of voice (TDM) lines. For example, it may be desirable for an ONT type to support the maximal number of voice lines intended for the particular ONT application. Thus, a Single-Family home Unit (SFU) ONT might have up to 4 telephony ports (each supporting a separate voice line), while a Multi-Dwelling Unit (MDU) serving 8-12 apartments might support up to twenty-four lines instead, and a ONT for business applications may be expandable (e.g. via the use of modules or cards that may be inserted into a backplane) to provide extra lines as needed. The average number of lines used in an application of one of such ONT types is typically less than the maximum number that may be supported by the ONT, and the voice ports of the ONT that are actually used, may be any subset combination of the ports that are available. Also, it will be understood that when new lines are provisioned or removed, the set of ports in use will change.

As described above, the SDT structure allows transporting N voice channels multiplexed onto a single ATM VC. The fact that different subsets of ports are in service at different ONTs may give rise to problems such as the following:
1. The channel allocation in the structure needs to be coordinated between the ONT and the voice gateway, which terminates the AAL1 layer, whenever a line is provisioned or removed.
2. Bandwidth management may become more complex. For example, applications such as Connection Admission Control, which determines whether a request for network resources will be granted to a new ATM connection, may need to cope with changes in bandwidth demand for voice.
3. The dynamic bandwidth of the structure may complicate problems of managing delay and delay variation (also called jitter).

Although ATM Adaptation Layer 2 (AAL2) supports dynamic allocation of channels and calls, such support also creates complexity. AAL2 also includes mechanisms for avoiding inconsistent delay (e.g. channels are not multiplexed to a single cell), but at the cost of larger delays in any configuration.

A data network (or portion thereof) may have a bandwidth capacity that exceeds the expected usage. For example, such a situation may be found on the periphery of a data network, especially in a case where the maximum number of terminals (e.g. user-network interfaces) is limited. In a particular example, a system that includes an OLT, a limited set of ONTs (e.g. 32 or 64), and a PON that connects the OLT to the ONTs may have a capacity for transferring data between the OLT and the ONTs that exceeds the expected usage. In some installations, such bandwidth may be simply wasted.

At least some of the embodiments as disclosed herein may be deployed in such a situation to allocate portions of the data bandwidth to channels of the system (e.g. ONT voice ports) that are supported in hardware but are not yet active. In some cases, bandwidth may be allocated to channels that are not even recognized yet by the system (e.g. ONT voice ports that are not yet provisioned). Potential advantages of such an application may include a reduced complexity in allocating system resources to channels that are newly active and/or newly provisioned (e.g. avoiding the need to reconfigure the data transport when a port is newly provisioned), in managing system bandwidth, and/or in managing problems of delay and jitter.

In a method according to an embodiment of the present invention, a fixed SDT structure is used that supports the transport of all of the voice ports available at an ONT, whether the port is currently provisioned or not. The structure may include a fixed channel allocation for each voice line, such that the relationship between ports and channels may also be fixed. Potential advantages that may be realized in an application of such a method include the following:
1. A very simple channel allocation may be created once for both peers of the AAL1 connection. Moreover, the allocation may remain unchanged even when voice lines are later activated or removed.
2. Bandwidth management and applications such as Connection Admission Control may be simplified, as the bandwidth requirements for a given ONT may be substantially constant.
3. Consistency of delay and delay variation may lead to more predictable requirements for system resources that need to handle such problems.

Because idle channels also consume bandwidth, the efficiency of bandwidth use by a fixed allocation technique may be less than optimal. However, AAL1 may typically employ partial cell fill techniques to minimize delay. Therefore the constant transport of idle lines may be viewed as another means of partial cell fill, as it also serves for the purpose of minimizing delay.

In one application of a method according to an embodiment of the invention, an ONT or ONU transports traffic (active and/or idle) corresponding to its N voice ports over a single VC that uses AAL1 SDT adaptation method. For example, all of the lines' bearer information (voice samples) and associated signaling may be transported across the PON to a AAL1 voice gateway that maps the voice channels to TDM onto a PSTN interface. Such an encapsulation method may be implemented to comply with ATM Forum specification AF-VTOA-0078, entitled Circuit Emulation Service Interoperability Specification Version 2.0 (CES-IS V2.0, January 1997, The ATM Forum Technical Committee, Mountain View, Calif.).

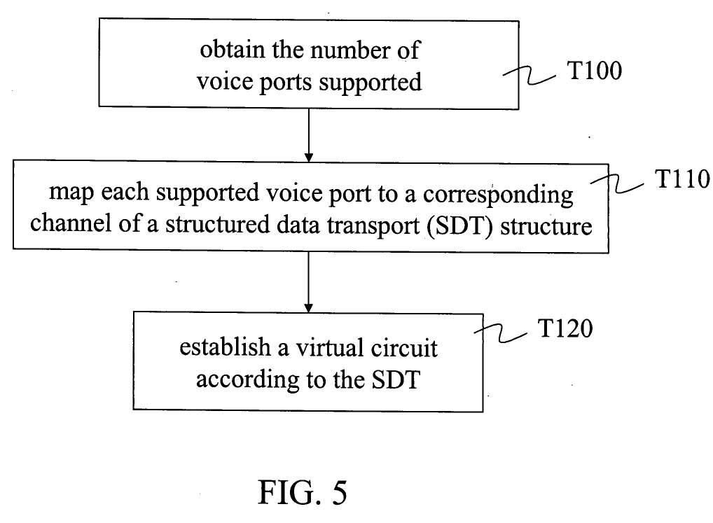

FIG. 5 shows a flowchart of a method according to an embodiment of the invention. Task T100 obtains the number of voice ports supported by the ONT (or a portion of the ONT). For example, task T100 may obtain the number of ports physically present on the ONT (or some portion thereof), or the number of ports that are currently operable (e.g. as configured in hardware (e.g. DIP switches) or firmware (e.g. nonvolatile RAM) of the ONT). In one implementation, the OLT performs task T100 by applying the ONT serial number or ONT type or model number (or similar ONT identifier) to a lookup table and reading out the number of voice ports supported by that ONT or ONT type. The ONT identifier may be received over the PON, for example, or may be otherwise inputted to the OLT (e.g. by a service technician, possibly via a web-based or wireless interface).

Task T110 applies a fixed mapping between each supported voice port and a channel of the SDT structure. For example, such a mapping may be as simple as port 1 uses channel 1, port 2 uses channel 2, and so on.

Task T120 establishes a virtual circuit according to the SDT. A channel assigned to a provisioned (in-service) port carries the bearer (voice) samples during an active call on that port. Channels that are associated with ports not currently in service (e.g. not currently provisioned), and channels associated with provisioned ports that are inactive (e.g. not off-hook), carry idle information, which may be comfort noise or silence. The signaling for idle channels will typically also be idle, as no call activity would normally be present.

In at least some applications of a method according to FIG. 5, the SDT channel structure does not change when a voice port is provisioned or removed.

In some cases, implementations of such a method may be employed to complement and/or simplify an application of partial cell fill. Partial cell fill for voice is typically used to lower the delay by limiting the number of voice samples per channel per cell. If an ONT has four voice ports, for example, and it is desired to limit the number of samples per channel per cell to six, then the partial cell fill may be set to twenty-four.

In one application of a method as shown in FIG. 5 to such an example, four channels are always transported, so that the number of samples per channel will not exceed six. Hence the packetization delay remains substantially constant over time, regardless of the number of lines actually in service at the ONT. In contrast, other methods may require adjustment of the partial cell fill whenever a line is activated or deactivated in order to keep the packetization delay fixed. It should be noted that in any method the packetization delay may not be precisely constant for every cell, due to a) the cell fill ratio not being a multiple of the number of channels, and b) to signaling bytes that are sent in some of the frames.

Delay management of voice may also be simplified in applications of embodiments of the invention, e.g. as a by-product of a fixed packetization delay. Mechanisms that may be affected by delay (such as schedulers, queuing arrangements and jitter buffers), for example, can be simplified when the traffic they handle has a more predictable behavior. In one such application, one or more jitter buffers for a voice VC according to an embodiment of the invention have a fixed allocation. Such a buffer may also be tuned and tested only once. With existing methods, jitter buffers are either set to the worst case, causing unnecessary excessive delay, or change dynamically, adding significant complexity. Other potential advantages of constant bandwidth and delay of voice traffic (which is typically of the highest priority) include simplifying the queuing and scheduling of other traffic types.

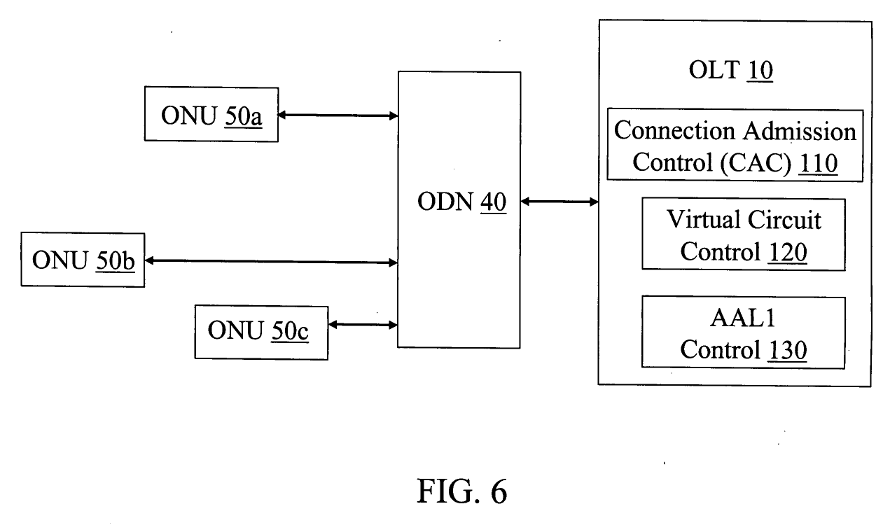

FIG. 6 shows a block diagram of an apparatus according to an embodiment of the invention. In this embodiment, OLT 10 comprises a Connection Admission Control (CAC) 110, a Virtual Circuit Control (VCC) 120, and an AAL1 Control 130. VCC 120 may be related to CAC 110, and AAL1 Control 130 may be related to VCC 120. It is understood by those familiar with the art that these structures may be implemented in hardware, firmware, and/or as software (e.g. one or more sets of machine-executable instructions) encoded on a computer-readable data storage medium (e.g. semiconductor memory).

Connection Admission Control (or Call Admission Control) 110 receives a request for network resources for an ONU 50 and determines whether the requested resources may be allocated. CAC 110 may also establish a service contract with the ONU. In response to an allocation by CAC 110 of ATM resources for voice ports of a new ONU, Virtual Circuit Control 120 establishes a virtual circuit. AAL1 Control 130 establishes the AAL1 layer and maps the voice ports of the ONU to channels on a structured data transport.

In such an embodiment, mechanisms for bandwidth management of the AAL1 virtual circuit may be simplified, as the circuit will have a fixed bandwidth over time. In at least some applications, the voice capacity for the ONT may be fixed based on the ONT type or model (e.g. indicating the number of voice ports that it supports).

In at least some applications of such an apparatus, Connection Admission Control 110 may be invoked only once for each ONT: when the circuit is being established (e.g. when the ONT is put into service). In contrast, existing methods involve increased complexity by dynamically allocating virtual circuits for new voice lines and/or by running the CAC multiple times on one virtual circuit when its capacity changes due to serving a different number of lines.

Some ONTs may have a number of sets of voice ports. For example, an ONT may have a modular configuration in which blocks of voice ports may be added via removably connected portions such as plug-in cards or other modules (e.g. inserted into a backplane of the ONT). For such ONTs, always transporting the maximal ONT voice bandwidth may become inefficient, and in such cases, an embodiment of the invention may provide multiple AAL1 virtual circuits for the ONT. For example, when another block of voice ports is desired (e.g. when another voice port card is inserted), a virtual circuit may be dedicated to transport all the lines for that block. The per-block virtual circuit may be implemented to operate as described above in a per-ONT virtual circuit case.

The foregoing presentation of the described embodiments is provided to enable any person skilled in the art to make or use the present invention. While specific embodiments of the invention have been described above, it will be appreciated that the invention as claimed may be practiced otherwise than as described. Various modifications to these embodiments are possible, and the generic principles presented herein may be applied to other embodiments as well.

An embodiment of the invention may be implemented in part or in whole as a hard-wired circuit (e.g. implemented on a computer interface card) and/or as a circuit configuration fabricated into one or more arrays of logic elements arranged sequentially and/or combinationally (e.g. combinatorially) and possibly clocked (e.g. one or more integrated circuits (e.g. ASIC(s)) or FPGAs). Likewise, an embodiment of the invention may be implemented in part or in whole as a firmware program loaded or fabricated into non-volatile storage (such as read-only memory or flash memory) as machine-readable code, such code being instructions executable by an array of logic elements such as a microprocessor or other digital signal processing unit.

Further, an embodiment of the invention may be implemented in part or in whole as a software program loaded as machine-readable code from or into a data storage medium, such as a magnetic, optical, magnetooptical, or phase-change disk or disk drive; or some form of a semiconductor memory such as ROM, RAM, or flash RAM, such code being instructions (e.g. one or more sequences) executable by an array of logic elements such as a microprocessor or other digital signal processing unit, which may be embedded into a larger device. Thus, the present invention is not intended to be limited to the embodiments shown above but rather is to be accorded the widest scope consistent with the principles and novel features disclosed in any fashion herein.

We claim:

1. A method of communications, said method comprising:
obtaining the number of voice ports supported by a particular optical networking unit (ONU);
mapping each of the supported voice ports to a corresponding channel of a structured data transport (SDT) structure; and
establishing a virtual circuit between the ONU and an optical line termination (OLT) according to the SDT structure.

2. The method of communications according to claim 1, wherein said number of supported voice ports is the number of voice ports physically present on the ONU.

3. The method of communications according to claim 1, wherein said number of supported voice ports is the number of different telephone lines supported by the ONU.

4. The method of communications according to claim 1, wherein said obtaining includes receiving a characteristic of the ONU and obtaining the number of voice ports based on the characteristic.

5. The method of communications according to claim 4, wherein the characteristic includes at least one of the group consisting of a serial number of the ONU and a type of the ONU.

6. The method of communications according to claim 1, wherein, during said mapping and said receiving, at least some of the supported voice ports are not yet configured to receive voice traffic from an optical network in communication with the ONU.

7. The method of communications according to claim 1, wherein at least one of the channels carries idle traffic.

8. The method of communications according to claim 1, wherein the SDT structure is an asynchronous transfer mode (ATM) adaptation layer 1 (AAL1) SDT structure.

9. The method of communications according to claim 1, wherein said number of supported voice ports is the maximum number of distinct telephone circuits that the ONU is configured to support.

10. The method of communications according to claim 1, wherein the ONU terminates an optical network.

11. The method of communications according to claim 1, said method comprising receiving traffic from the ONU, wherein said traffic is formatted according to the SDT structure.

12. The method of communications according to claim 1, said method comprising:
subsequent to said establishing a virtual circuit, provisioning one of the supported voice ports; and
subsequent to said provisioning, transferring data between said OLT and said provisioned voice port according to the SDT structure.

13. An optical line termination (OLT) comprising:
a connection admission control (CAC) configured to obtain the number of voice ports supported by an optical networking unit (ONU);
an adaptation layer control configured to establish a structured data transport (SDT) structure; and
a virtual circuit control configured to establish a virtual circuit between the OLT and the ONU according to the SDT structure,
wherein the OLT is configured to map each of the voice ports to a corresponding channel of the SDT structure.

14. The OLT according to claim 13, wherein said number of supported voice ports is the number of voice ports physically present on the ONU.

15. The OLT according to claim 13, wherein said number of supported voice ports is the number of different telephone lines supported by the ONU.

16. The OLT according to claim 13, wherein said CAC is configured to obtain the number of voice ports based on a received characteristic of the ONU.

17. The OLT according to claim 16, wherein the characteristic includes at least one of the group consisting of a serial number of the ONU and a type of the ONU.

18. The OLT according to claim 13, wherein, when the virtual circuit is established, at least some of the supported voice ports are not yet configured to receive voice traffic from an optical network in communication with the ONU.

19. The OLT according to claim 13, wherein at least one of the channels carries idle traffic.

20. The OLT according to claim 13, wherein the SDT structure is an asynchronous transfer mode (ATM) adaptation layer 1 (AAL1) SDT structure.

21. The OLT according to claim 13, wherein said number of supported voice ports is the maximum number of distinct telephone circuits that the ONU is configured to support.

22. The OLT according to claim 13, wherein the ONU terminates an optical network.

23. The OLT according to claim 13, wherein said OLT is configured to receive traffic from the ONU, wherein said traffic is formatted according to the SDT structure.

24. A data storage medium having instructions executable by an array of logic elements, said instructions describing a method comprising:
obtaining the number of voice ports supported by a particular optical networking unit (ONU);
mapping each of the supported voice ports to a corresponding channel of a structured data transport (SDT) structure; and
establishing a virtual circuit between the ONU and an optical line termination (OLT) according to the SDT structure.

25. The data storage medium according to claim 24, wherein said number of supported voice ports is the number of voice ports physically present on the ONU.

26. The data storage medium according to claim 24, wherein said number of supported voice ports is the number of different telephone lines supported by the ONU.

27. The data storage medium according to claim 24, wherein said obtaining includes receiving a characteristic of the ONU and obtaining the number of voice ports based on the characteristic.

28. The data storage medium according to claim 27, wherein the characteristic includes at least one of the group consisting of a serial number of the ONU and a type of the ONU.

29. The data storage medium according to claim 24, wherein, during said mapping and said receiving, at least some of the supported voice ports are not yet configured to receive voice traffic from an optical network in communication with the ONU.

30. The data storage medium according to claim 24, wherein at least one of the channels carries idle traffic.

31. The data storage medium according to claim 24, wherein the SDT structure is an asynchronous transfer mode (ATM) adaptation layer 1 (AAL1) SDT structure.

32. The data storage medium according to claim 24, wherein said number of supported voice ports is the maximum number of distinct telephone circuits that the ONU is configured to support.

33. The data storage medium according to claim 24, wherein the ONU terminates an optical network.

34. The data storage medium according to claim 24, said method comprising receiving traffic from the ONU, wherein said traffic is formatted according to the SDT structure.

35. The data storage medium according to claim 24, said method comprising:
subsequent to said establishing a virtual circuit, provisioning one of the supported voice ports; and
subsequent to said provisioning, transferring data between said OLT and said provisioned voice port according to the SDT structure.

36. An optical line termination (OLT) comprising:
means for obtaining the number of voice ports supported by an optical networking unit (ONU);
means for mapping each of the voice ports to a corresponding channel of a structured data transport (SDT) structure;
means for establishing a virtual circuit between the OLT and the ONU according to the SDT structure.

37. A method of communications, said method comprising:
obtaining the number of voice ports supported by a removably connected portion of an optical networking unit (ONU);
mapping each of the supported voice ports to a corresponding channel of a structured data transport (SDT) structure; and
establishing a virtual circuit between the ONU and an optical line termination (OLT) according to the SDT structure.

38. The method of communications according to claim 37, wherein the removably connected portion is inserted into a backplane of the ONU.

39. The method of communications according to claim 37, said method comprising:
subsequent to said establishing a virtual circuit, provisioning one of the supported voice ports; and
subsequent to said provisioning, transferring data between said OLT and said provisioned voice port according to the SDT structure.

40. A system configured to transfer data, said system comprising:
an optical networking unit (ONU) including at least one user-network interface (UNI);
an optical line termination (OLT), said OLT comprising a connection admission control (CAC) configured to obtain the number of voice ports supported by the ONU, an adaptation layer control configured to establish a structured data transport (SDT) structure, and a virtual circuit control configured to establish a virtual circuit between the OLT and the ONU according to the SDT structure; and
a passive optical network (PON) configured to carry the virtual circuit and to terminate at the ONU and at the OLT.

41. The system according to claim 40, wherein said number of supported voice ports is the number of voice ports physically present on the ONU.

42. The system according to claim 40, wherein said CAC is configured to obtain the number of voice ports based on a received characteristic of the ONU,
wherein the characteristic includes at least one of the group consisting of a serial number of the ONU and a type of the ONU.

43. The system according to claim 40, wherein, when the virtual circuit is established, at least some of the supported voice ports are not yet configured to receive voice traffic from an optical network in communication with the ONU.

44. The system according to claim 40, wherein the SDT structure is an asynchronous transfer mode (ATM) adaptation layer 1 (AAL1) SDT structure.

45. The system according to claim 40, wherein said number of supported voice ports is the maximum number of distinct telephone circuits that the ONU is configured to support.

46. The system according to claim 40, wherein said OLT is configured to receive traffic from the ONU, wherein said traffic is formatted according to the SDT structure.
